(19) United States
(12) Patent Application Publication
(10) Pub. No.: US 2008/0174180 A1
(43) Pub. Date: Jul. 24, 2008

(54) METHOD FOR THE OPERATION OF A WIND FARM

(75) Inventors: Mark Jurkat, Norderstedt (DE); Jorg Lehmann, Weyhe (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Nordex Energy GmbH, Norderstedt (DE)

(21) Appl. No.: 11/764,395

(22) Filed: Jun. 18, 2007

(30) Foreign Application Priority Data
Jan. 20, 2007 (DE) 10 2007 003 030.6

(51) Int. Cl. H02J 3/46; F03D 9/00; H02P 3/02

(52) U.S. Cl. 307/80; 290/44; 307/85

(57) ABSTRACT

A method for the operation of a wind farm with a multiplicity of wind energy plants, which are connected to a wind farm control unit, wherein each wind energy plant can perform a power reduction for purposes of maintenance or examination, characterised in that each one of the wind energy plants can perform the power reduction in response to a signal of the wind farm control unit, and the wind farm control unit co-ordinates the signals for the wind energy plants such that a power decrease of the wind farm does not exceed a predetermined amount and/or a provided power of the wind farm does not exceed a predetermined velocity of change, and that at all times at least one wind energy plant is not affected by the power reduction.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a method for the operation of a wind farm with a wind farm control unit and a multiplicity of wind energy plants, which are connected to the wind farm control unit, wherein each wind energy plant can perform a power reduction for purposes of maintenance or examination.

Today's wind farms consist of several, up to hundreds of wind energy plants, which are connected at a common grid connection point and are normally connected to a power supply grid of an electric utility via the same. In this, the individual wind energy plants can be combined to such a wind farm as being distributed across a greater area or even in individual groups which have a spatial distance from each other. Each individual wind energy plant has its own control unit, which controls and regulates the operation of the wind energy plant.

Furthermore, there is a superordinate wind farm control unit, which monitors the operation of the entire wind farm and of the individual wind energy plants. Via a data line to the individual wind energy plants, the wind farm control unit can collect information regarding the wind energy plants and send control signals to the individual wind energy plants. For instance, it is known to stop all wind energy plants of a wind farm through a central command of the wind farm control unit and to cut off the wind farm completely from the grid.

From the German patent DE 103 20 087 B4, the entire contents of which is incorporated herein by reference, a method for the operation of a wind farm is known by which when starting a wind farm in particular, the power received from the power supply grid can be limited. A power take-out from the power supply grid is necessary after a complete shutdown of the wind farm for instance, in order to orient a wind energy plant to be started towards the wind direction. In order to keep the comparatively expensive amount of power to be taken out from the power supply grid as small as possible, the patent proposes to start one single or a group of wind energy plants at first and thereafter to perform the start of additional wind energy plants utilizing the power provided from the wind energy plants started at first.

The operation of wind energy plants necessitates maintenance at regular intervals. Typical maintenance works are greasing of gearboxes or bearings and an examination of mechanical or electric components of the wind energy plant. In order to be able to perform such examination and maintenance works, a reduction of the power generated by the wind energy plant is often required. For many of the maintenance works, suitable routines are laid down in the control units of the wind energy plants, which perform the necessary power reduction of the wind energy plant after a manual starting command, for instance.

The power reductions of individual wind energy plants undertaken for maintenance purposes or for conducting examination routines reduce the power generated by the entire wind farm correspondingly. Considerable variations of the generated power of the wind farm may take place, wherein the grid connection rules preset by the grid operators may be possibly violated and even grid errors, up to complete grid breakdowns, can occur

On the basis of this, it is the objective of the present invention to indicate a method for the operation of a wind farm which reduces unwanted variations of the active and/or reactive power fed by the wind farm due to maintenance and/or examination works.

### BRIEF SUMMARY OF THE INVENTION

The method according to the present invention serves for the operation of a wind farm with a multiplicity of wind energy plants, which are connected to a wind farm control unit, wherein each wind energy plant can perform a power reduction for purposes of maintenance or examination, and each one of the wind energy plants can perform the power reduction in response to a signal of the wind farm control unit, and the wind farm control unit co-ordinates the signals for the wind energy plants such that a power decrease of the wind farm does not exceed a predetermined amount and/or a provided power of the wind farm does not exceed a predetermined velocity of change, and wherein at all times at least one wind energy plant is not affected by the power reduction.

Thus, with the aid of its own individual control unit, each wind energy plant is capable to perform a power reduction necessary for the respective maintenance purposes. However, the power reduction does not take place autonomously, but as a response to a signal emitted by the wind farm control unit. By suitable co-ordination of the signals for the various wind energy plants, the wind farm control unit can take care that the variations of the power generated by the wind farm, i.e. optionally of the active and/or the reactive power, do not exceed a certain degree. It is provided to pre-set a maximum amount for the absolute power decrease of the wind farm due to the maintenance works, and/or for the velocity of change of the power of the wind farm. In contrast to a complete shut-down of the entire wind farm, at all times at least one wind energy plant is not affected by the power reduction in the method according to the present invention.

The invention draws advantage from the fact that the maintenance works on individual wind energy plants do not have to be performed at an exactly predetermined point of time, but rather within a certain time slot. This permits to shift the power reduction of a certain wind energy plant in time and to match it with the maintenance works of other wind energy plants according to need. By doing so, external pre-settings for the power generation of the wind farm, through grid connection rules in particular, and necessary maintenance intervals for the wind energy plants can be fulfilled at the same time.

In this, the power reduction of a wind energy plant comprises in principle every reduction of the power generated by the wind energy plant which is necessary for purposes of maintenance and/or examination. For instance, running through the blade angle of attack across a greater range can be necessary for an examination of the displacement of the blade angle of attack As a consequence of the displacement of the blade angle of attack, there is a decrease of the power generated by the wind energy plant. However, the wind energy plant can remain connected to the power supply grid and it can continuously feed power into the grid.

In a preferred embodiment of the present invention, a wind energy plant is cut off from the grid at a power reduction. The wind energy plant is completely turned off. This is necessary for a series of maintenance works. Thus, these maintenance works are accompanied by a particularly high power decrease of the wind farm, so that the method according to the present invention is particularly advantageous.

According to a further preferred embodiment of the present invention, the wind farm control unit presets maintenance dates for the wind energy plants and emits a signal for power reduction of the assigned wind energy plant when a maintenance date is reached. Thus, the necessary maintenance works are centrally managed by the wind farm control unit. In doing so, the wind farm control unit can pre-set the maintenance dates from on the beginning, such that variations of the power decrease of the wind farm are minimised.

In a further preferred embodiment of the present invention, the wind farm control unit determines the maintenance dates for the wind energy plants on the basis of operation data of the wind energy plants. The operation data of each individual wind energy plant or those of different groups of wind energy plants can be acquired. Among the operation data are for instance data about wear, the capacity utilization or the operation duration of individual components of the wind energy plant or of the entire wind energy plant, the duration of the operation on the grid, the amount of power fed, the number of coupling-up processes, the number of changes of the mode of operation, temperature courses, rotational speed courses and so on. Taking into account such operation data allows the wind farm control unit to perform an optimum pre-setting of the maintenance data.

According to a further preferred embodiment of the present invention, each wind energy plant sends a request to the wind farm control unit before a power reduction, and the wind farm control unit emits the signal for power reduction. Here, the necessity of a maintenance work in or on a single wind energy plant is detected. Before the necessary power reduction is performed by the wind energy plant, a corresponding request is made to the wind farm control unit. The wind farm control unit answers the request and in this it can issue an approval through the emission of the signal for power reduction. The approval can be also denied or given only at a later point in time. In doing so, it is possible that the wind farm control unit sends additional signals to the wind energy plant, an explicit denial of the request for instance. Through the system of request and approval, the wind farm control unit can effectively co-ordinate the power reductions of the individual wind energy plants even in the case that maintenance intervals and dates of the individual wind energy plants are not known in the wind farm control unit.

According to a further preferred embodiment of the present invention, the request takes place as a reaction to the incidence of a condition which is automatically acquired by the wind energy plant. The automatically acquired condition may be the end of a time interval, exceeding a predetermined temperature or exceeding or falling below a threshold value through another measurement value The condition is automatically acquired by the wind energy plant, i.e. the control unit of the wind energy plant in particular. Thus, the necessity of a certain maintenance work is automatically detected by the wind energy plant and transmitted to the wind farm control unit.

In a further preferred embodiment of the present invention, the request takes place as a reaction to a manual input, for instance. The manual input may be a stop command for a wind energy plant, which is given through the control unit of the wind energy plant. Before obeying the stop command, the wind energy plant makes a corresponding request to the wind farm control unit in this case and it performs the accompanying power reduction only after approval through the wind farm control unit. By doing so, it is achieved that even at plural manual stop commands given to different wind energy plants at the same time, no excessive power reduction of the wind farm occurs.

According to a further preferred embodiment of the present invention, the wind farm control unit gives a signal for power reduction to a predetermined number at maximum of wind energy plants simultaneously. Through this, the power decrease of the wind farm is limited to the power decay effectuated by the predetermined number of wind energy plants. Also, it is possible to set a predetermined number of wind energy plants which are affected at maximum by a simultaneous power reduction.

In a further preferred embodiment of the present invention, the wind farm control unit, after emission of a signal for power reduction, emits a further signal for power reduction only after a predetermined time interval. Due to this, the power reduction of a second wind energy plant takes place only after the end of the predetermined time interval after the beginning of the power reduction of a first wind energy plant. Through this, a simultaneous or closely neighbouring in time reduction of the power of plural wind energy plants is avoided.

In a further preferred embodiment of the present invention, after emission of a first signal for power reduction of a wind energy plant, the wind farm control unit emits a further signal for power reduction only after the change of a state or mode of operation of the wind energy plant and/or after the completion of the first process of power reduction. Thus, the power reduction of a further wind energy plant occurs only when the process of power reduction of the first wind energy plant is completed or the first wind energy plant has reached a certain operating state. Through this, the power reduction processes of different wind energy plants can be better matched to each other.

According to a further preferred embodiment of the present invention, a priority is assigned to a request. The priority reflects the urgency of the pending maintenance- or examination measures, so that this urgency can be taken into account at the approval of the power reduction through the wind farm control unit. By doing so, the wind farm control unit can initiate particularly important maintenance- or examination measures instantly, whereas less important maintenance- or examination measures can be deferred.

According to a further preferred embodiment of the present invention, a power reduction of a wind energy plant takes place without a signal of the wind farm control unit in the case that the wind energy plant has detected an emergency situation. An emergency case is at hand when the maintenance measure to be performed tolerates no delay. In this case, the necessary power reduction is performed if needed even without corresponding approval through the wind farm control unit. Due to this, maintenance measures immediately relevant to security in particular can be always performed.

### BRIEF DESCRIPTION OF THE VIEW OF THE DRAWING

The present invention is explained in more detail by means of an example of its realisation represented in FIG. 1.

FIG. 1 shows a wind farm according to the present invention in a strongly simplified, schematic representation.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

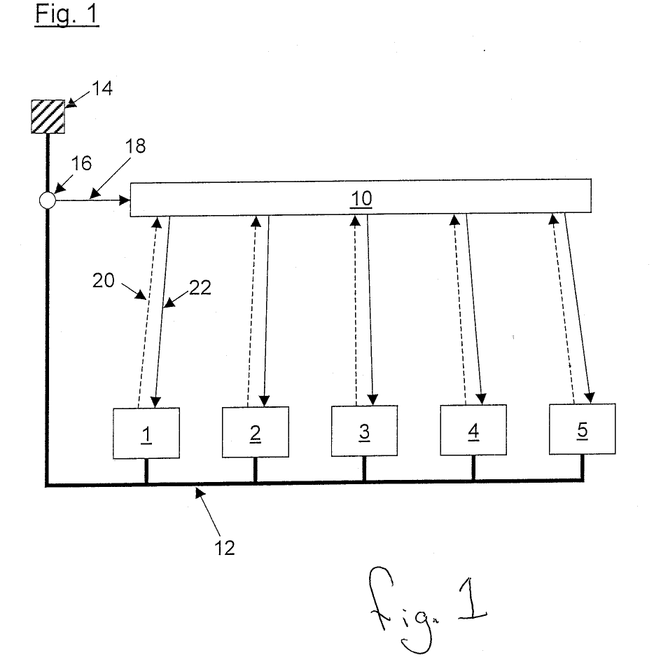

The wind farm represented in FIG. 1 comprises five wind energy plants 1 to 5, which are connected to the central wind farm control unit 10 via a not shown data line. Further, the wind energy plants 1 to 5 are connected with a common grid connection point 16 via a power cable 12. The grid connection point 16 on its part is connected with a power supply grid 14 of an electric utility. The wind energy plants 1 to 5 can feed active and/or reactive power into the power supply grid 14 via the grid connection point 16.

The wind farm control unit 10 is connected to the grid connection point 16 via the line 18 and it can acquire measurement signals and/or status messages from the grid connection point 16.

Each of the wind energy plants 1 to 5 comprises its own control unit, which is responsible for the operation of the wind energy plant. Among others, there is information in the respective control units of the individual wind energy plants 1 to 5 when certain maintenance and/or examination works are to be performed. For instance, when a maintenance measure is pending in the wind energy plant 1, which makes a power reduction of the wind energy plant 1 necessary, the control unit of the wind energy plant 1 sends a request 20 to the wind farm control unit via the existing data line to the wind farm control unit 10. The wind farm control unit 10 analyses the request 20 and checks whether at the respective point in time, a power reduction of the wind energy plant 1 is consistent with a predetermined maximum power decrease of the wind energy plant and/or with a predetermined maximum velocity of change of the power generated by the wind farm. When this is the case, the wind energy plant 10 sends an approval signal 22 to the wind energy plant 1 Thereafter, the control unit of the wind energy plant 1 starts a routine laid down in the control unit, which performs the power reduction which is necessary for the respective maintenance measure.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for the operation of a wind farm with a multiplicity of wind energy plants (1-5), which are connected to a wind farm control unit (10), wherein each wind energy plant can perform a power reduction for purposes of maintenance or examination, characterised in that each one of the wind energy plants can perform the power reduction in response to a signal (22) of the wind farm control unit (10), and the wind farm control unit co-ordinates the signals for the wind energy plants such that a power decrease of the wind farm does not exceed a predetermined amount and/or a provided power of the wind farm does not exceed a predetermined velocity of change, and that at all times at least one wind energy plant is not affected by the power reduction.

2. A method according to claim 1, characterised in that a wind energy plant (1-5) is cut off from the grid at a power reduction.

3. A method according to claim 1, characterised in that the wind farm control unit (10) presets maintenance dates for the wind energy plants (1-5) and emits the signal for power reduction of the assigned wind energy plant when a maintenance date is reached.

4. A method according to claim 3, characterised in that the wind farm control unit (10) determines the maintenance dates for the wind energy plants (1-5) on the basis of operation data of the wind energy plants.

5. A method according to claim 1, characterised in that each wind energy plant (1-5) sends a request (20) to the wind farm control unit (10) before a power reduction, and the wind farm control unit (10) emits the signal (22) for power reduction.

6. A method according to claim 5, characterised in that the request (20) takes place as a reaction to the incidence of a condition which is automatically acquired by the wind energy plant (1-5),

7. A method according to claim 5, characterised in that the request (20) takes place as a reaction to a manual input.

8. A method according to claim 5, characterised in that the wind farm control unit (10) gives a signal (22) for power reduction to a predetermined number at maximum of wind energy plants (1-5) simultaneously,

9. A method according to claim 5, characterised in that the wind farm control unit (10), after emission of a signal (22) for power reduction, emits a further signal for power reduction only after a predetermined time interval.

10. A method according to claim 5, characterised in that after the emission of a first signal (22) for power reduction of a wind energy plant (1-5), the wind farm control unit (10) emits a further signal for power reduction only after the change of a state or mode of operation of the wind energy plant (1-5) and/or after the completion of the first process of power reduction.

11. A method according to claim 5, characterised in that a priority is assigned to a request (20).

12. A method according to claim 1, characterised in that a power reduction of a wind energy plant (1-5) takes place without a signal of the wind farm control unit in the case that the wind energy plant (1-5) has detected an emergency situation.
